(19) United States
(12) Patent Application Publication
(10) Pub. No.: US 2012/0151677 A1
(43) Pub. Date: Jun. 21, 2012

(54) METHOD AND SYSTEM FOR CABLE MANAGEMENT

(75) Inventors: Jabez Augustine Yesudhas, Bangalore (IN); Vinay Narasimhamurthy, Bangalore (IN); Baskar Somasundaram, Bangalore (IN)

(73) Assignee: GENERAL ELECTRIC COMPANY, Schenectady, NY (US)

(21) Appl. No.: 12/972,991

(22) Filed: Dec. 20, 2010

(51) Int. Cl. A61G 7/05; F16L 3/123

(52) U.S. Cl. 5/600; 248/65

(57) ABSTRACT

A device attachable to a patient table having a rail on at least one side of the table to accommodate at least one user interface having a cable connected thereto. The device includes a cable guiding mechanism to receive the cable. The cable guiding mechanism includes a guiding rod, and the cable guiding mechanism is attachable beneath the rail. The cable guiding mechanism also includes a cover having an opening mechanism provided through out a length of the cover. The cover includes a front end, a rear end and a middle portion. The middle portion of the cover is attached to the guiding rod through a movable connecting unit.

### FIELD OF THE INVENTION

This invention relates generally to cable management systems, and more particularly to, managing cables from various user interfaces around a patient table.

### BACKGROUND

Medical procedures such as imaging procedures can include different user interfaces attached to the patient table. Generally a rail is provided along the side of the patient table and different user interfaces are placed on the rail. In a typical design of the patient table, a cable from the user interface is not managed properly and lies freely on the floor. This results in cables getting trapped with the external accessories kept close to the patient table. When the patient table moves, the cable may get cut or destroyed. The free lying cable also can increase a likelihood of the risk of foot entrapment for the users.

Some of the existing solution suggests providing a cable-guiding device below the patient table. However this will increase the height of the patent table and since the mechanism is provided below the patient table, it's very difficult to change the interfaces or accessories from one side to another or to remove the guiding mechanism from the patient table. However during a medical procedure, easy removal and attachment of cables are essential. Quick removal or attachment of the cables is required for enabling the user to easily change the position of the user interface from one side of the table to another. So there exist a need for a simple cable management device and method. Further, the guiding mechanism should be able to accommodate the cable movement and length in accordance with the patient table movement.

Thus, a need exists for a simple and quick method and device for managing cables around a patient table.

### BRIEF SUMMARY

The above-mentioned shortcomings, disadvantages and problems are addressed herein which will be understood by reading and understanding the following specification.

One embodiment of the present invention provides a device attachable to a patient table having a rail on at least one side of the table to accommodate at least one user interface having a cable connected thereto. The device comprises: a cable guiding mechanism to receive the cable, the cable guiding mechanism having a guiding rod, the cable guiding mechanism being attachable beneath the rail; a cover having an opening mechanism provided through out a length of the cover; the cover having a front end, a rear end and a middle portion, the middle portion of the cover being attached to the guiding rod through a movable connecting unit.

In another embodiment, a patient table is disclosed. The patient table comprises: a movable patient support; a rail provided along a length of the patient support to accommodate a user interface; and a cable management device including: a cable guiding mechanism provided below the rail, the guiding mechanism being attached along a width of the rail, a cover having an opening mechanism provided throughout a length of the cover; the cover having a front end, a rear end and a middle portion, the middle portion of the cover being attached to the cable guiding mechanism through a movable connecting unit, and an interface board provided at one end of the patient table.

In yet another embodiment, a patient table in combination with a medical imaging system is disclosed. The system comprises: a cable guiding device that is detachable and provided on at least one side of the patient table for accommodating a user interface; the cable guiding device being including a guiding rod; a cover having an opening mechanism provided through out a length of the cover; the cover having a front end, a rear end and a middle portion, the middle portion of the cover being attached to the guiding rod through a movable connecting unit.

Various other features, objects, and advantages of the invention will be made apparent to those skilled in the art from the accompanying drawings and detailed description thereof.

### BRIEF DESCRIPTION OF THE DRAWINGS

FIG. 1 shows a patient table with a cable management device as described in an embodiment of the invention;

FIG. 2 shows a device attachable to a patient table for managing cables exterior to a patient table as described in an embodiment of the invention; and

FIG. 3 shows a flattened view of a cover that is described with reference to a cable management device as described in an embodiment of the invention.

### DETAILED DESCRIPTION

In the following detailed description, reference is made to the accompanying drawings that form a part hereof, and in which is shown by way of illustration specific embodiments that may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken as limiting the scope of the invention. To the extent that the figures illustrate diagrams of the functional blocks of various embodiments, the functional blocks are not necessarily indicative of the division between hardware circuitry. Thus, for example, one or more of the functional blocks may be implemented in as single unit. It should be understood that the various embodiments are not limited to the arrangements and instrumentality shown in the drawings.

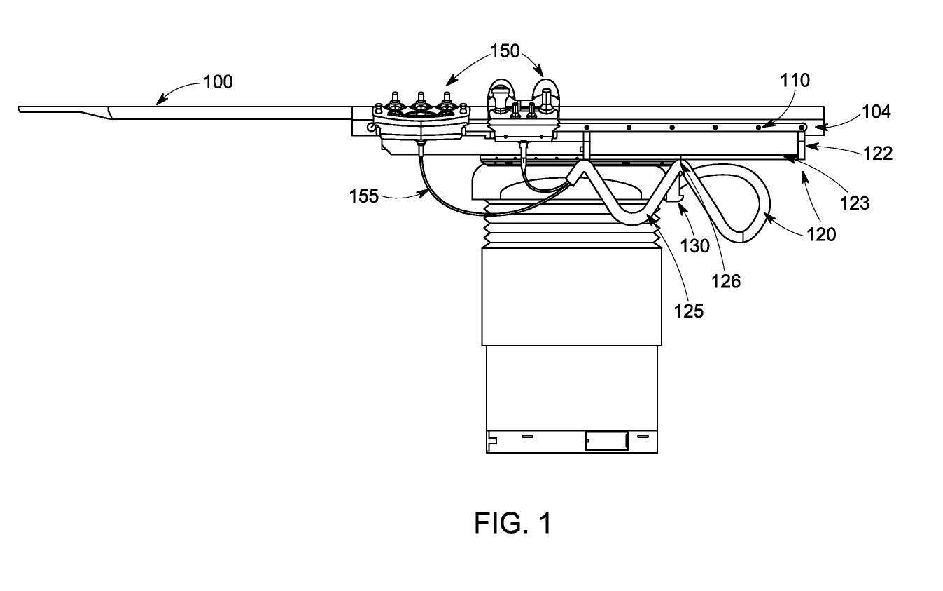

FIG. 1 shows patient table 100 with cable management device 120 as described in an embodiment of the invention. The patient table 100 could be any patient-supporting device that could be used in any medical procedure including diagnostic procedure. The patient table 100 is provided with at least one user interface 150 that could be used during a medical procedure. The user interfaces 150 could belong to patient table control accessories and/or various accessories that are placed near to the patient table 100. The interfaces 150 are connected or mounted on a rail 110 attached to at least one side of the patient table 100. The cables 155 hanging from the interfaces 150 are managed using a cable management device 120 attachable to the patient table 100.

The device 120 guides the cables 155 of the user interfaces 150 from the rails 110 of the table 100 to an interface board 130 to which the cables 155 are connected. The device 120 comprises a guiding mechanism 122 and a cover 125 that encloses the interface cables 155. The guiding mechanism 122 comprises a guiding rod 123 that guides movement of cover 125. The device 120 could be provided on both sides of table 100 to take care of the user interface cables 155 that are lying both at right hand side (RH) and Left hand side (LH) of table 100.

The cover 125 is attached to the guiding rod 123 through a movable connecting unit 126 which will assist the cover 125 in moving along the guiding rod 123.

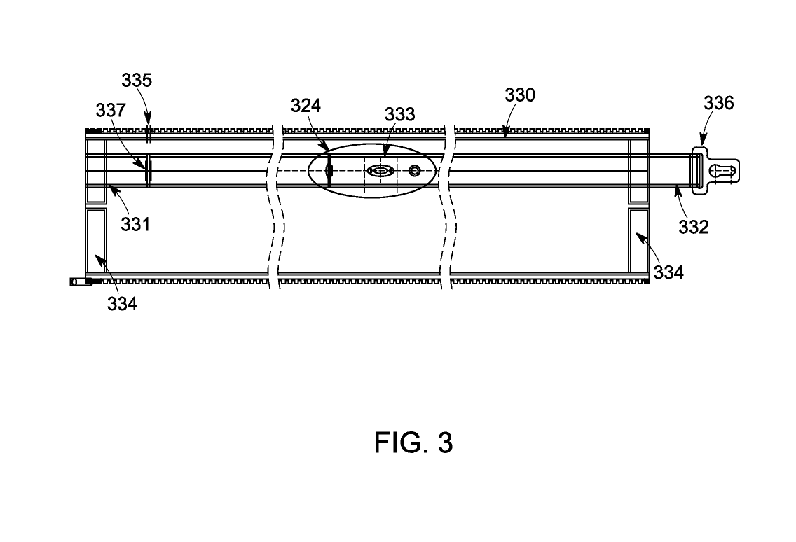

The cover 125 is provided with opening mechanism (described in detail later in FIG. 3) along the length of the cover 125 for quick opening of the cover 125 to incorporate the cables 155. In an embodiment, the cover 125 is provided in a curvy fashion and it stretches to accommodate the lateral movement of the patient table 100. The length of the cover 125 is adjusted such that the cables 155 or the cover 125 is not lying on the ground even when the patient table 100 is in its lowest height position, yet accommodating the full table movement.

In an embodiment, the patient table 100 can be a vascular patient positioner and the user interfaces 150 and the external accessories could include electrical junction boxes, gas box, tram etc. In an embodiment the cover is a sheath.

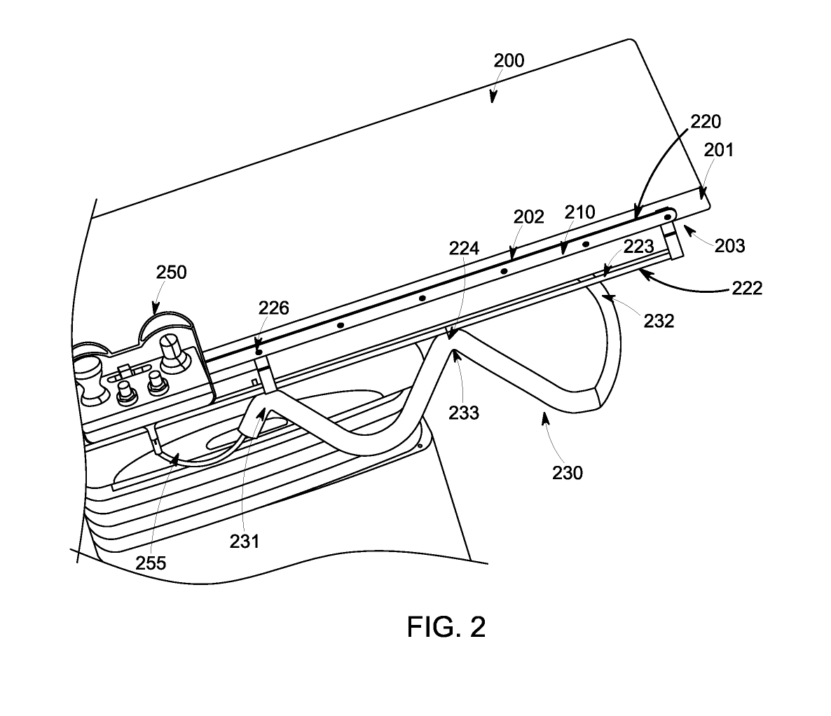

FIG. 2 shows the cable management device 220 attachable to a patient table 200 for managing cables 255 exterior to the patient table 200 as described in an embodiment of the invention. The patient table 200 is provided with at least one user interface 250 that could be used during a medical procedure. The interfaces 250 are connected or mounted on a rail 210 attached to at least one side of the patient table 200. The cables 255 hanging from the interfaces 250 is managed using the cable management device 220 attachable to the patient table 200.

The cable management device 220 guides the cables 255 of the user interfaces 250 from the rails 210 of the table 200 to an interface board 130 (shown in FIG. 1) of the interface 250. The device 220 comprises at least one cable guiding mechanism 222 attached beneath the rail 210 along the side 201 of the patent table 200. The guiding mechanism 222 is provided with a guiding rod 223 and a cover 230 for enclosing the cables 255, the cover 230 is configured to guide the cables 255 along the guiding rod 223.

The rail 210 is attached to upper portion 202 of one side 201 of the patient table 200 and the guiding the rod 223 is attached to the lower portion 203 of the side 201 of the patient table 200. A channel 104 (shown in FIG. 1) is defined between the upper portion 202 and lower portion 203 of the side 201 of the patient table 200, indicating depth of the patient table 200. The guiding mechanism 222 comprises the guiding rod 223 fixed below the rail 210 and at least one connecting unit 224 such as sliding ring to which the cover 230 is attachable. The connecting unit 224 assists the cover 230 in guiding along the guiding rod 223 during the longitudinal movement of the patient table 200 and/or the interface 250. The guiding mechanism 222 could be fixed between the rail 210 and the channel 104 using some fixing mechanism 226 such as screws.

The cable management device 220 further comprises at least one cover 230 having an opening mechanism (described in detail later in FIG. 3) provided through out the length of the cover 230. The cover 230 has a front end 231, rear end 232 and a middle portion 233. The middle portion 233 of the cover being attached to the guiding rod 223 through the at least one movable connecting unit 224.

The cover 230 is provided with an opening mechanism 335 (shown in FIG. 3) through out the length of the cover 230 for easy opening of the cover 230. The opening mechanism 335 could include snap fit buttons, dual sides adhesive tapes, zip etc. The front end 231 of the cover 230 is attached to bottom of the rail 210. The rear end 232 of the cover 230 is attachable to an interface board 130 shown in FIG. 1. The middle portion 231 of the cover 230 is attachable to the guiding rod 223 through the movable connecting unit 224. The length of the cover 230 is defined to accommodate the length of the cables 255 to enclose free hanging cables of the user interface 250. The front end 231 and rear end 232 of the cover 230 is provided with a dual lock 334 (shown In FIG. 3) for locking the cables 255 from slipping. Front end 231 and rear end 232 could be provided with quick release mechanisms (described below) to connect to the rail 210 and interface board 130 (See FIG. 1) respectively.

In an embodiment, the cover 230 is provided with a quick release mechanism 337 on both ends 231, 232 of the cover 230. Rear end 232 of the cover 230 is provided with a buckle 336 (shown in FIG. 3) that will help the cover 230 to be connected to an interface board (see reference 130 in FIG. 1). Quick release mechanisms 337 such as turn button fasteners 337 are provided at front end 231 of the cover to fix the cover 230 to the rail 210. A quick release mechanism 337 such as turn button fastener or snap fit button are provided onto the movable connecting unit 224.

In an embodiment, the quick release mechanism 337 is provided with fool proof to ensure that cover 230 is not fixed in reverse direction.

The excess cable length may be looped outside the cover 230 in the form of loop tie and near the interface board (see reference 130 in FIG. 1). The length of the cover 230 is defined to accommodate the longitudinal movement of the table 200 and/or user interface 250, yet to be short enough to ensure that the cover 230 does not lie on the ground when the table 200 is at lowermost position. The cover 230 is initially in curvy fashion to accommodate the longitudinal movement of the patient table 200. When the table 200 moves in the longitudinal direction, the connecting unit 224 or movable ring slides over the guiding rod 223 and the curvy fashioned cover 230 stretches to accommodate the longitudinal movement. During the lateral movement of the patient table 200, the movable connecting unit 224 swivels on the guiding rod 223 ensuring lessened stress on the cable cover 230 and the cables 255.

In an embodiment, the cover 230 with enclosed cables 255 can be completely detached and swapped from right hand side of the patient table 200 to the left hand side of the patient table 200. Without removing the cables 255 with the help of quick release mechanism 337 provided on the front and rear end of the cover 230, the cables 255 can be swapped. This will help to easily interchange all the user interfaces 250 from one side of the table 200 to another.

The opening mechanism 335 such as zip, dual lock etc ensures quick removal of a single cable 255 from the cover 230 on one side and inserting into other side of the cover 230. Thus ensuring quick swapping of single user interface 250 from one side of the table 200 to another. Alternately multiple covers 230 could be used for multiple cables 255 from the interfaces 250.

The cover 230 is designed such that it can be completely removed and cleaned. Dust free and washable material such a polyether cloth may be used as the cover 230.

FIG. 3 shows a flattened view of a cover 330 that is described with reference to the cable management device as described in an embodiment of the invention. The cover 330 is provided with a front end 331, rear end 332 and middle portion 333. The middle portion 333 is attachable to the guiding rod 223 through a movable connecting unit 324. The cover 330 is provided with an opening mechanism 335 such a buttons or any adhesive tape or similar things through out the length of the cover 330 for easy opening of the cover 330. A quick release mechanism 337 such as a buckle 336 is provided at the rear end of the cover 332 and a turn button faster 337 is provided at the front end 331 of the cover 330. The front end 331 and rear end 332 of the cover 330 are provided with a dual lock 334 for locking the cables from slipping.

The cable management device described herein helps in guiding the cables in a defined path without entangling the cables during the table movement, there by eliminating the risk of the cables being cut or the hazard caused when a user steps on the free lying cables on the floor. Since the cables are grouped and guided, the mechanism minimizes the risk of cable entangling with the accessories and the exam interruptions. The subject matter described herein also facilitates protecting cables from falling on the floor even when table is at minimal height. Easy removal and attachment of cables for swapping the user interfaces from one side of the table to another side is also achieved. Also the guiding mechanism is accommodated within the width of the table thus ensures no hindrance to the user or patient movement.

In an embodiment, a method of managing cables around the patient table 100 and 200 is disclosed. The method comprises providing a cable management device 120 and 220 for managing the cables 155 and 255 around patient tables 100 and 200 respectively. Method further comprises providing a cover 125, 230, 330 for covering the cables 155 and 250. The cover 125, 230, 330 is provided in a curvy fashion, having an opening mechanism 335 through out the length of the cover 125, 230, 330 and moves along a guiding mechanism 122, 222 to accommodate the movement of the patient table 100 and 200.

Thus various embodiments of the invention describe a method and cable management device 120 and 220 for managing the cables 155 and 255 around patient tables 100 and 200 respectively. The device includes a guiding mechanism 122, 222 and a cover 125, 230, 330 for accommodating the cables 155, 255, hanging around the patient table 100, 200. The cover 125, 230, 330 being attached to the guiding mechanism 122, 222 through at least one movable connecting unit 124, 226, 324 such as ring.

Embodiments of the present invention facilitate easy swapping of the user interfaces from one side of the patient table to another.

Though the method and device is explained with reference to patient table, the application of the invention need not be limited patient tables. The invention could be applied to management cable lying around any apparatus or system.

As used herein, an element or step recited in the singular and proceeded with the word “a” or “an” should be understood as not excluding plural elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

Exemplary embodiments are described above in detail. The assemblies and methods are not limited to the specific embodiments described herein, but rather, components of each assembly and/or method may be utilized independently and separately from other components described herein. Further the steps involved in the workflow need not follow the sequence in which there are illustrated in figures and all the steps in the work flow need not be performed necessarily to complete the method.

While the invention has been described with reference to preferred embodiments, those skilled in the art will appreciate that certain substitutions, alterations and omissions may be made to the embodiments without departing from the spirit of the invention. Accordingly, the foregoing description is meant to be exemplary only, and should not limit the scope of the invention as set forth in the following claims.

We claim:

1. A device attachable to a patient table having a rail on at least one side of the table to accommodate at least one user interface having a cable connected thereto, the device comprising:
a cable guiding mechanism to receive the cable, the cable guiding mechanism having a guiding rod, the cable guiding mechanism being attachable beneath the rail;
a cover having an opening mechanism provided through out a length of the cover; the cover having a front end, a rear end and a middle portion, the middle portion of the cover being attached to the guiding rod through a movable connecting unit.

2. The device as claimed in claim 1, wherein the guiding rod extends along a width of the rail.

3. The device as claimed in claim 1, wherein the front end of the cover is attached to a bottom portion of the rail through a quick release mechanism.

4. The device as claimed in claim 1, wherein the rear end of the cover is attached to an interface board along the rail of the patient table.

5. The device as claimed in claim 1, wherein the cover is made of a washable, non-inflammable cloth.

6. The device as claimed in claim 1, wherein the front end and the rear end of the cover are provided with a dual lock to lock the cover to the guiding mechanism.

7. The device as claimed in claim 1, wherein middle portion of the cover is connected to the movable connecting unit by a fastener and a quick release mechanism.

8. The device as claimed in claim 1, wherein a Length of the cover accommodates the user interface along the rail.

9. The device as claimed in claim 1, wherein a length of the cover places the cover above a ground level.

10. The device as claimed in claim 1, wherein a cable length of the cable outside the cover is looped near the holding mechanism by a loop tie.

11. The device as claimed in claim 1, wherein the cover guides more than one cable to more than one user interface.

12. The device as claimed in claim 1, wherein the device includes multiple covers to guide multiple cables from multiple user interfaces.

13. A patient table, comprising:
a movable patient support;
a rail provided along a length of the patient support to accommodate a user interface; and
a cable management device including:
a cable guiding mechanism provided below the rail, the guiding mechanism being attached along a width of the rail,
a cover having an opening mechanism provided throughout a length of the cover; the cover having a front end, a rear end and a middle portion, the middle portion of the cover being attached to the cable guiding mechanism through a movable connecting unit, and
an interface board provided at one end of the patient table.

14. The patient table as claimed in claim 13, wherein the front end of the cover is attached to a bottom portion of the rail through a quick release mechanism and the rear end of the cover is attached to the interface board.

15. The patient table as claimed in claim 13, wherein the cover appears in a curvy fashion.

16. The patient table as claimed in claim 15, wherein when the patient support moves in a longitudinal direction, a movable ring slides over the cable guiding mechanism forming the cover in a linear stretch.

17. The patient table as claimed in claim 16, wherein the movable ring is configured to swivel when the patient support moves in a lateral direction.

18. The patient table as claimed in claim 13, wherein the cover is swappable between a right hand side and a left hand side of the patient table.

19. A patient table in combination with a medical imaging system, comprising:
a cable guiding device that is detachable and provided on at least one side of the patient table for accommodating a user interface; the cable guiding device being including a guiding rod;
a cover having an opening mechanism provided through out a length of the cover; the cover having a front end, a rear end and a middle portion, the middle portion of the cover being attached to the guiding rod through a movable connecting unit.

20. The patient table as claimed in claim 19, wherein a length of the cover is defined to accommodate both a longitudinal movement of the patient table and a movement of the user interface along the rail.
